(19) United States
(12) Patent Application Publication
(10) Pub. No.: US 2024/0429851 A1
(43) Pub. Date: Dec. 26, 2024

(54) MOTOR DRIVING DEVICE AND REFRIGERATION CYCLE APPLICATION APPARATUS

(71) Applicant: Mitsubishi Electric Corporation, Tokyo (JP)

(72) Inventors: Shoei TSUTSUMI, Tokyo (JP); Shinya TOYODOME, Tokyo (JP); Kazunori HATAKEYAMA, Tokyo (JP)

(21) Appl. No.: 18/701,329

(22) PCT Filed: Nov. 5, 2021
(86) PCT No.: PCT/JP2021/040708

§ 371 Date: Apr. 15, 2024

(51) Int. Cl. H02P 29/024; F25B 31/02

(52) U.S. Cl. CPC H02P 29/0241; F25B 31/02

(57) ABSTRACT

A motor driving device includes an inverter and a controller, and the inverter has first switching elements of an upper arm, first freewheeling diodes, second switching elements of a lower arm, and second freewheeling diodes. The controller outputs a control signal for setting all of the second switching elements of the lower arm in an ON state when an open failure of any one of the first switching elements of the upper arm is detected, and outputs a control signal for setting all of the plurality of first switching elements of the upper arm in the ON state when an open failure of any one of the second switching elements of the lower arm is detected.

### CROSS REFERENCE TO RELATED APPLICATION

This application is a U.S. national stage application of PCT/JP2021/040708 filed on Nov. 5, 2021 the contents of which are incorporated herein by reference.

### TECHNICAL FIELD

The present disclosure relates to a motor driving device and a refrigeration cycle application apparatus.

### BACKGROUND

In an air conditioner, when a motor (e.g., permanent magnet synchronous motor) is rotated forcibly due to an external disturbance factor (e.g., outside wind) or the like, the motor works as an electric generator and generates regenerative voltage, and there is a danger that a motor driving device is broken by the regenerative voltage. As a countermeasure against this problem, there has been proposed a technology of restraining the regenerative voltage occurring when the motor is rotated forcibly within a withstand voltage of an inverter by repeating a short-circuiting operation and an opening operation between the inverter and the motor when the regenerative voltage higher than or equal to a threshold value is detected (see Patent Reference 1, for example).

### PATENT REFERENCE

Patent Reference 1: Japanese Patent Application Publication No. 2009-284747 (see FIG. 1 and paragraph 0013, for example)

However, in the above-described technology, when an unexpected opening operation or short-circuiting operation occurs to a switching element as a component of the inverter due to a certain factor, there is a danger that a state in which an excessive current flows into the motor or a state in which excessive voltage is applied to a capacitor connected to the inverter is caused by the regenerative voltage and a failure is caused to the motor driving device.

### SUMMARY

An object of the present disclosure, which has been made to resolve the above-described problem, is to provide a motor driving device and a refrigeration cycle application apparatus capable of inhibiting the occurrence of a failure due to the regenerative voltage.

A motor driving device in the present disclosure includes an inverter to receive a DC voltage from a DC power supply and to output a voltage to a motor, and control circuitry to detect a failure of the inverter and to control the inverter based on the detected failure. The inverter has a plurality of first switching elements of an upper arm connected between a plus side of the DC power supply and the motor and a plurality of first freewheeling diodes respectively connected in parallel with the plurality of first switching elements, and a plurality of second switching elements of a lower arm connected between a minus side of the DC power supply and the motor and a plurality of second freewheeling diodes respectively connected in parallel with the plurality of second switching elements. While controlling all of the plurality of first switching elements and all of the plurality of the second switching elements to be in an OFF state in order to stop driving the motor, the control circuitry executes a control operation of outputting a control signal for setting all of the plurality of second switching elements of the lower arm in an ON state when an open failure of any one of the first switching elements of the upper arm of the inverter is detected, and of outputting a control signal for setting all of the plurality of first switching elements of the upper arm in the ON state when an open failure of any one of the second switching elements of the lower arm of the inverter is detected.

Another motor driving device in the present disclosure includes an inverter to receive a DC voltage from a DC power supply and to generate a voltage to be inputted to a motor, and control circuitry to detect a failure of the inverter and to control the inverter based on the detected failure. The inverter has a plurality of first switching elements of an upper arm connected between a plus side of the DC power supply and the motor and a plurality of first freewheeling diodes respectively connected in parallel with the plurality of first switching elements, and a plurality of second switching elements of a lower arm connected between a minus side of the DC power supply and the motor and a plurality of second freewheeling diodes respectively connected in parallel with the plurality of second switching elements. While controlling all of the plurality of first switching elements and all of the plurality of the second switching elements to be in an OFF state in order to stop driving the motor, the control circuitry executes a control operation of outputting a control signal for setting all of the plurality of first switching elements of the upper arm in an ON state when a short-circuiting failure of any one of the first switching elements of the upper arm of the inverter is detected, and outputs a control signal for setting all of the plurality of second switching elements of the lower arm in the ON state when a short-circuiting failure of any one of the second switching elements of the lower arm of the inverter is detected.

A refrigeration cycle application apparatus in the present disclosure includes the motor driving device and a refrigeration cycle device including a motor driven by the motor driving device.

According to the present disclosure, the occurrence of a failure of the motor driving device due to the regenerative voltage can be inhibited.

### BRIEF DESCRIPTION OF THE DRAWINGS

FIG. 1 is a diagram schematically showing the configuration of a motor driving device according to a first embodiment.

FIG. 2 is a circuit diagram showing the configuration of an inverter in FIG. 1.

FIG. 3 is a diagram showing an example of paths of current at a time of occurrence of regenerative voltage when all of switching elements of the inverter in FIG. 1 are set in an OFF state by use of thick lines.

FIG. 4A is a diagram showing paths of a regenerative current when all of lower arm switching elements of the inverter in FIG. 1 are set in an ON state by use of thick lines, and FIG. 4B is a diagram showing paths of the regenerative current when all of upper arm switching elements of the inverter in FIG. 1 are set in the ON state by use of thick lines.

FIG. 5 is a diagram showing an example of paths of the regenerative current when an open failure has occurred to a switching element of the lower arm of the inverter in FIG. 1 by use of thick lines.

FIG. 6 is a waveform chart showing an example of DC voltage, d-axis and q-axis currents, phase currents, and a revolution speed of a permanent magnet synchronous motor when the open failure in FIG. 5 occurs.

FIG. 7 is a diagram showing an example of paths of the regenerative current when an open failure has occurred to a switching element and a freewheeling diode of the lower arm of the inverter in FIG. 1 by use of thick lines.

FIG. 8 is a waveform chart showing an example of the DC voltage, the d-axis and q-axis currents, the phase currents, and the revolution speed of the permanent magnet synchronous motor when the open failure in FIG. 7 occurs.

FIG. 9 is a flowchart showing the failure detection of the inverter and the operation of the motor driving device.

FIGS. 10A and 10B are circuit diagrams showing paths of current when the failure detection is executed.

FIGS. 11A and 11B are circuit diagrams showing paths of current when the failure detection is executed.

FIGS. 12A and 12B are circuit diagrams showing paths of current when the failure detection is executed.

FIG. 13 is a flowchart showing the failure detection of the inverter and the operation of the motor driving device.

FIG. 14 is a diagram schematically showing the configuration of a motor driving device according to a second embodiment.

FIG. 15 is a diagram schematically showing the configuration of a motor driving device according to a third embodiment.

FIG. 16 is a diagram showing the configuration of an air conditioner as a refrigeration cycle application apparatus according to a fourth embodiment.

### DETAILED DESCRIPTION

A motor driving device according to each embodiment and an air conditioner as a refrigeration cycle application apparatus according to an embodiment will be described below with reference to the drawings. The following embodiments are just examples and it is possible to appropriately combine embodiments and appropriately modify each embodiment.

### First Embodiment

### Configuration of Motor Driving Device

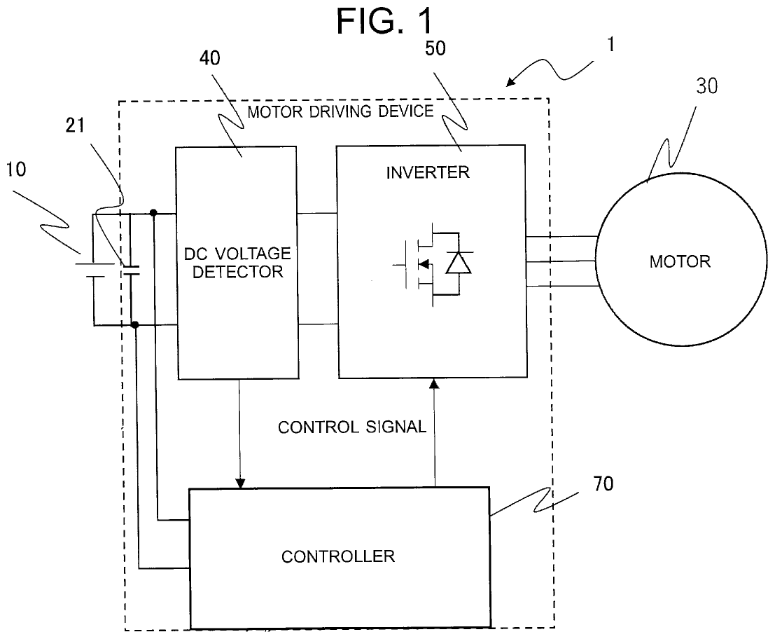

FIG. 1 is a diagram schematically showing the configuration of a motor driving device 1 according to a first embodiment. The motor driving device 1 includes a DC voltage detector 40 that detects DC voltage at an output end of a DC power supply 10 and outputs a DC voltage signal representing the DC voltage, an inverter 50, and a controller 70. The inverter 50 receives the DC voltage from the DC power supply 10 as an input and outputs voltage to a motor 30. The motor 30 is a multiphase (e.g., three-phase, having a U-phase, a V-phase, and a W-phase) permanent magnet synchronous motor. The controller 70 detects a failure of the inverter 50 and controls the inverter 50 based on the detected failure.

The inverter 50 includes a plurality of switching elements (referred to also as “first switching elements”) 51, 52 and 53 of an upper arm 50a connected between a plus side of the DC power supply 10 and the motor 30 and a plurality of freewheeling diodes (referred to also as “first freewheeling diodes”) 51a, 52a and 53a of the upper arm 50a respectively connected in parallel with the plurality of switching elements 51, 52 and 53. The inverter 50 includes a plurality of switching elements (referred to also as “second switching elements”) 54, 55 and 56 of a lower arm 50b connected between a minus side of the DC power supply 10 and the motor 30 and a plurality of freewheeling diodes (referred to also as “second freewheeling diodes”) 54a, 55a and 56a of the lower arm 50b respectively connected in parallel with the plurality of switching elements 54, 55 and 56.

When an open failure of any one of the switching elements 51 to 56 is detected, the controller 70 executes the following control. The controller 70 outputs a control signal for setting all of the plurality of switching elements 54, 55 and 56 of the lower arm 50b in an ON state when the open failure of any one of the switching elements of the upper arm 50a of the inverter 50 (i.e., one or more switching elements out of the switching elements 51, 52 and 53) is detected, and outputs a control signal for setting all of the plurality of switching elements 51, 52 and 53 of the upper arm 50a in the ON state when the open failure of any one of the switching elements of the lower arm 50b of the inverter 50 (i.e., one or more switching elements out of the switching elements 54, 55 and 56) is detected. This control is referred to also as control at the time of the open failure.

When a short-circuiting failure of any one of the switching elements 51 to 56 is detected, the controller 70 executes the following control. The controller 70 outputs the control signal for setting all of the plurality of switching elements 51, 52 and 53 of the upper arm 50a in the ON state when the short-circuiting failure of any one of the switching elements of the upper arm 50a of the inverter 50 (i.e., one or more switching elements out of the switching elements 51, 52 and 53) is detected, and outputs the control signal for setting all of the plurality of switching elements 54, 55 and 56 of the lower arm 50b in the ON state when the short-circuiting failure of any one of the switching elements of the lower arm 50b of the inverter 50 (i.e., one or more switching elements out of the switching elements 54, 55 and 56) is detected. This control is referred to also as control at the time of the short-circuiting failure.

The motor driving device 1 is desired to have a function of executing both of the control at the time of the open failure and the control at the time of the short-circuiting failure described above. However, the motor driving device 1 may also be configured to have a function of only one of the control at the time of the open failure and the control at the time of the short-circuiting failure described above.

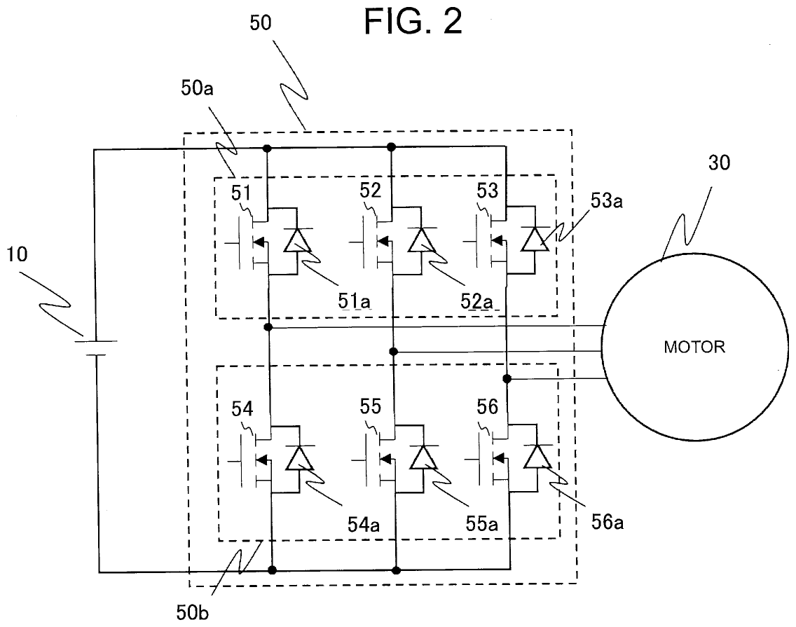

FIG. 2 is a circuit diagram showing the configuration of the inverter 50 in FIG. 1. The inverter 50 is a three-phase voltage type full-bridge inverter. The inverter 50 includes three IGBTs (Insulated Gate Bipolar Transistors), namely, three switching elements 51, 52 and 53, to which the freewheeling diodes 51a, 52a and 53a connected to the positive side of the DC power supply 10 are connected in parallel and three IGBTs, namely, three switching elements 54, 55 and 56, to which the freewheeling diodes 54a, 55a and 56a connected to the negative side of the DC power supply 10 are connected in parallel. Each of the switching elements 51, 52 and 53 and each of the switching elements 54, 55 and 56 are connected in series, and neutral points between the positive side and the negative side are connected to the phases (that is, the U-phase, the V-phase, and the W-phase) of the motor 30. The connection condition of the motor 30 is a star connection (Y connection) or a delta connection (Δ connection), and a selector switch for switching the connection condition may be provided. For example, the controller 70 controls the inverter 50 so as to restrain the regenerative voltage based on a DC voltage detection value detected by the DC voltage detector 40.

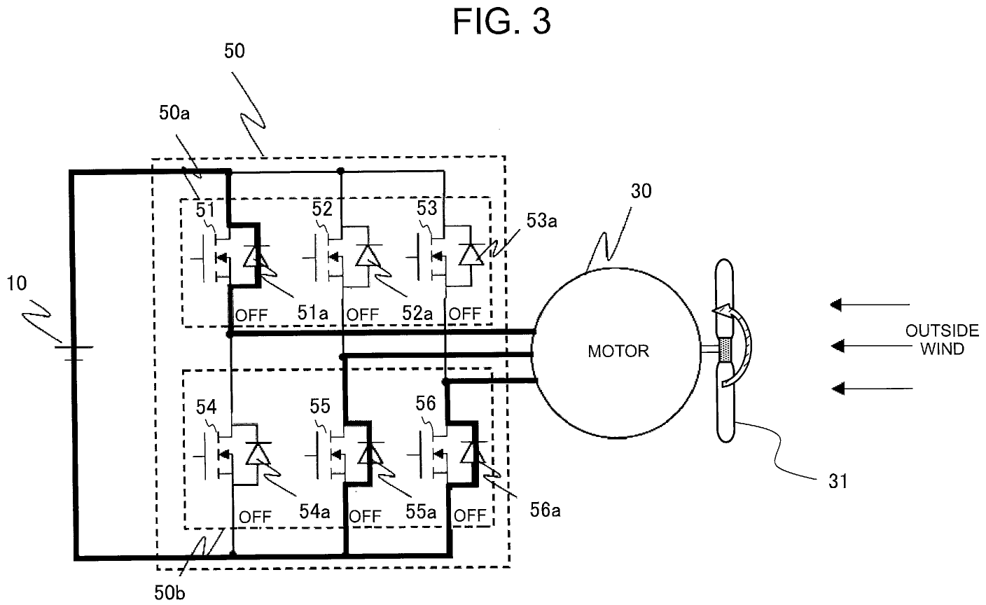

FIG. 3 is a diagram showing an example of paths of current at a time of occurrence of regenerative voltage when all of the switching elements 51 to 56 of the inverter 50 in FIG. 1 are set in an OFF state by use of thick lines. When the driving of the motor 30 is stopped and all of the three switching elements 51, 52 and 53 of the upper arm 50a and the three switching elements 54, 55 and 56 of the lower arm 50b in the inverter 50 are in the OFF state (i.e., open state), the regenerative voltage occurs if the motor 30 is rotated forcibly. Due to this regenerative voltage, a current flows into the freewheeling diodes 51a to 56a of the upper arm 50a and the lower arm 50b and is rectified, and DC voltage is applied to the DC power supply 10. The DC voltage applied to the DC power supply 10 is detected by the DC voltage detector 40 (shown in FIG. 1) and the detected DC voltage detection value is outputted to the controller 70.

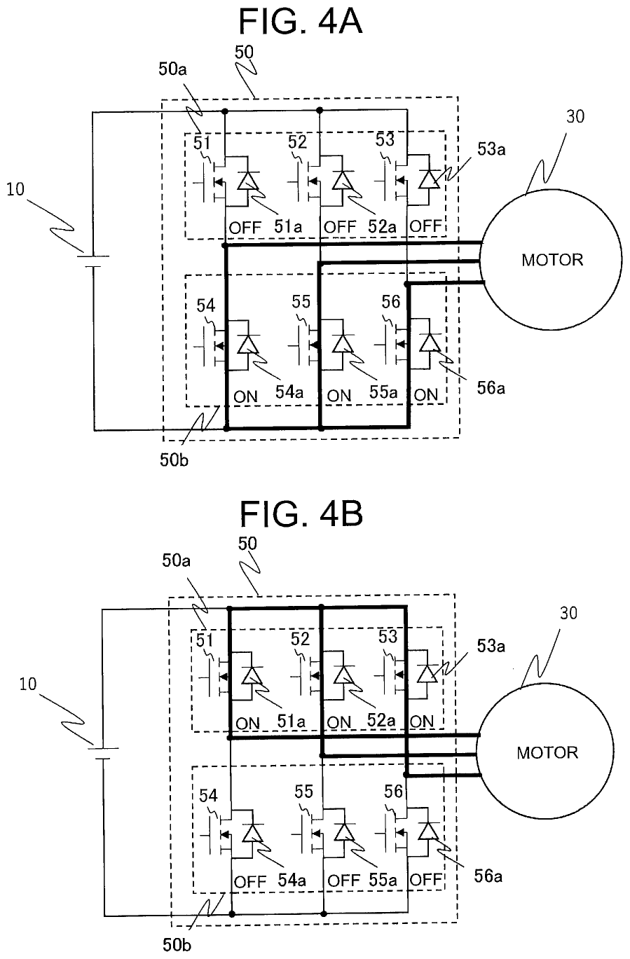

FIG. 4A is a diagram showing paths of the regenerative current when all of the switching elements 54, 55 and 56 of the lower arm 50b of the inverter 50 in FIG. 1 are set in the ON state and all of the switching elements 51, 52 and 53 of the upper arm 50a are set in the OFF state by use of thick lines. FIG. 4B is a diagram showing paths of the regenerative current when all of the switching elements 51, 52 and 53 of the upper arm 50a of the inverter 50 in FIG. 1 are set in the ON state and all of the switching elements 54, 55 and 56 of the lower arm 50b are set in the OFF state by use of thick lines. In the state shown in FIG. 4A or FIG. 4B, the regenerative voltage occurring in the motor 30 can be attenuated in the motor 30. Therefore, in the state shown in FIG. 4A or FIG. 4B, the regenerative current flows in the paths indicated by the thick lines in FIG. 4A or FIG. 4B and thus the regenerative voltage is not applied to the DC power supply 10 or a smoothing capacitor 21 connected between terminals of the DC power supply 10.

Therefore, in the first embodiment, when the open failure of any one of the switching elements 51, 52 and 53 of the upper arm 50a of the inverter 50 is detected, the controller 70 forms a circuit equivalent to that in FIG. 4A by setting all of the plurality of switching elements 54, 55 and 56 of the lower arm 50b, as the arm on the opposite side, in the ON state. When the open failure of any one of the switching elements 54, 55 and 56 of the lower arm 50b of the inverter 50 is detected, the controller 70 forms a circuit equivalent to that in FIG. 4B by setting all of the plurality of switching elements 51, 52 and 53 of the upper arm 50a, as the arm on the opposite side, in the ON state.

Further, in the first embodiment, when the short-circuiting failure of any one of the switching elements 51, 52 and 53 of the upper arm 50a of the inverter 50 is detected, the controller 70 forms a circuit equivalent to that in FIG. 4B by outputting the control signal for setting all of the plurality of switching elements 51, 52 and 53 of the upper arm 50a, as the arm on the same side, in the ON state. When the short-circuiting failure of any one of the switching elements 54, 55 and 56 of the lower arm 50b of the inverter 50 is detected, the controller 70 forms a circuit equivalent to that in FIG. 4A by outputting the control signal for setting all of the plurality of switching elements 54, 55 and 56 of the lower arm 50b, as the arm on the same side, in the ON state.

This makes it possible to restrain the regenerative voltage occurring when the motor 30 is rotated forcibly within the withstand voltage of the inverter 50, and the regenerative voltage can be prevented from being applied to the DC power supply 10 or the smoothing capacitor 21 connected between the terminals of the DC power supply 10. Further, it is possible to reduce the danger that an excessive demagnetization current flows into the motor 30 or voltage higher than or equal to a withstand voltage is applied to the DC power supply 10 due to an unexpected short-circuiting path or open state and that leads to malfunction of the circuit.

### Operation in First Embodiment

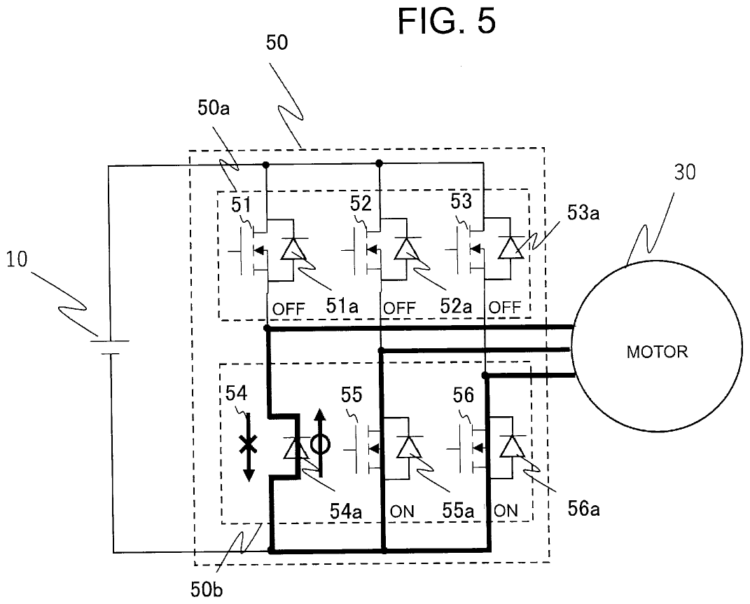

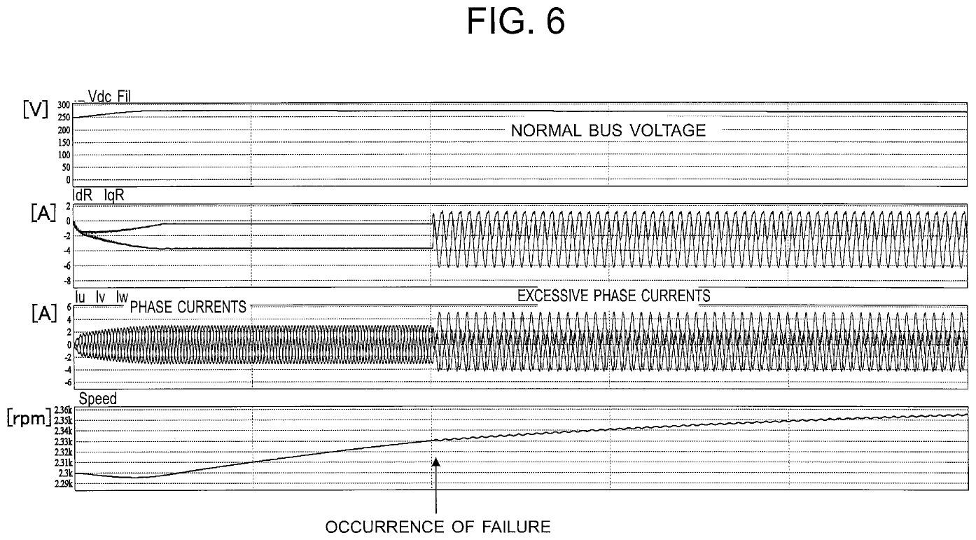

FIG. 5 is a diagram showing an example of paths of the regenerative current when the open failure has occurred to the switching element 54 of the lower arm 50b of the inverter 50 in FIG. 1 due to a certain cause by use of thick lines. FIG. 6 is a waveform chart showing an example of the DC voltage Vdc [V], d-axis and q-axis currents IdR and IqR [A], phase currents Iu, Iv, and Iw [A], and revolution speed [rpm] of the motor 30 when the open failure in FIG. 5 occurs. In this case, as shown in FIG. 5 and FIG. 6, due to the open state of the switching element 54, the current that should originally flow through the switching elements 54, 55 and 56 flows into the motor 30 through the freewheeling diode 54a alone. At that time, the phase current flowing into the motor 30 becomes excessive as shown in FIG. 6, and thus there is a possibility of demagnetizing permanent magnets of the motor 30.

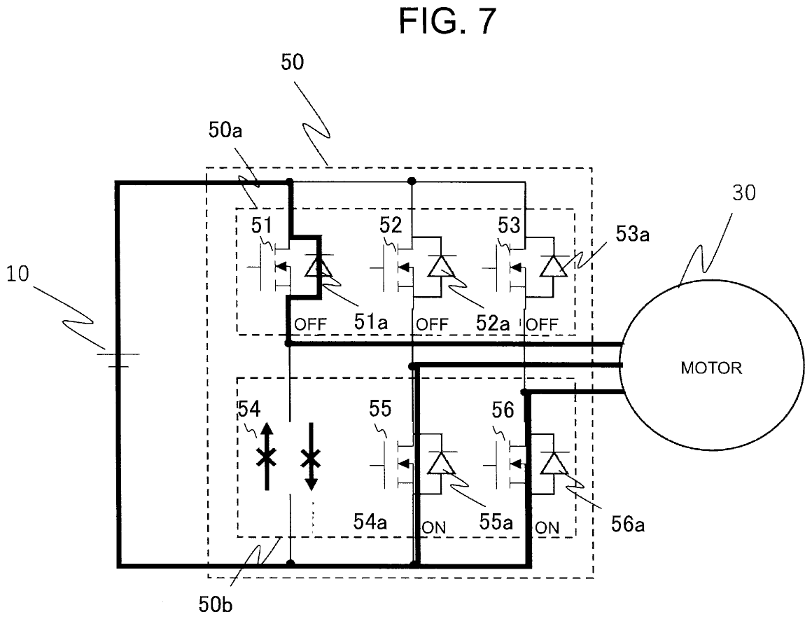

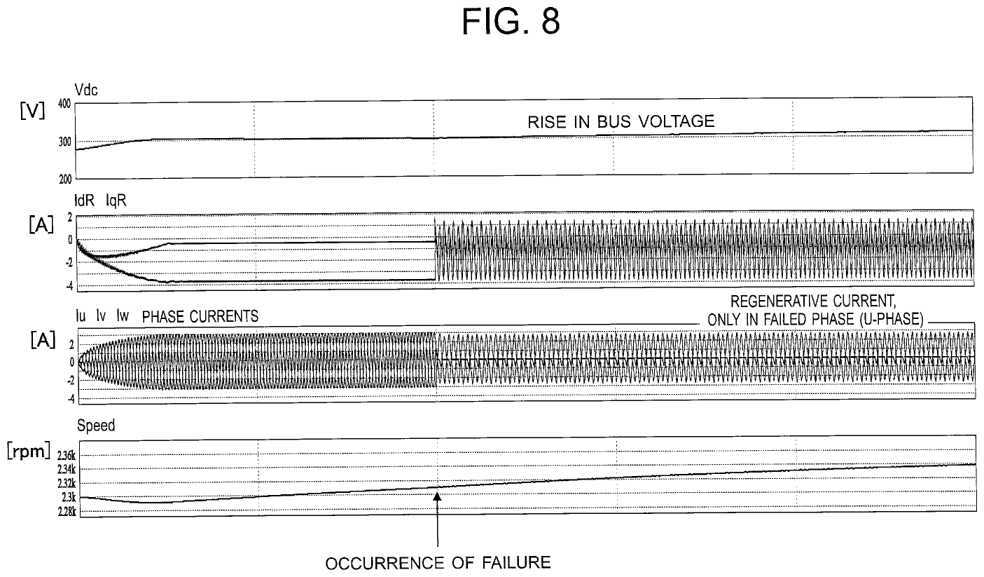

FIG. 7 is a diagram showing an example of paths of the regenerative current when the open failure has occurred to the switching element 54 and the freewheeling diode 54a of the lower arm 50b of the inverter 50 in FIG. 1 by use of thick lines. FIG. 8 is a waveform chart showing an example of the DC voltage Vdc [V], the d-axis and q-axis currents IdR and IqR [A], the phase currents Iu, Iv, and Iw [A], and the revolution speed [rpm] of the motor 30 when the open failure in FIG. 7 occurs. In this case, if it is attempted to set all of the switching elements 54, 55, and 56 of the lower arm 50b in the ON state, the current paths indicated by the thick lines in FIG. 7 are formed. Due to the open state of the switching element 54 and the freewheeling diode 54a of the lower arm 50b, the regenerative current that should originally be confined in the lower arm 50b flows into the DC power supply 10's side through the freewheeling diode 51a in the upper arm 50a. Accordingly, DC voltage is applied to the DC power supply 10 and it becomes impossible to restrain the regenerative voltage. Further, negative voltage occurs between both ends of the switching element 54 and the freewheeling diode 54a in the open failure, and when the voltage exceeds the absolute maximum rating, the voltage can cause malfunction of the inverter 50. The negative voltage mentioned here means voltage between switching elements occurring due to the open failure, and is voltage much greater compared to a voltage drop occurring due to a property of an element such as the ON voltage of a switching element. As shown in FIG. 8, the DC voltage Idc applied to the DC power supply 10 gradually rises with the passage of time.

### Operation When Failure of Inverter Is Detected

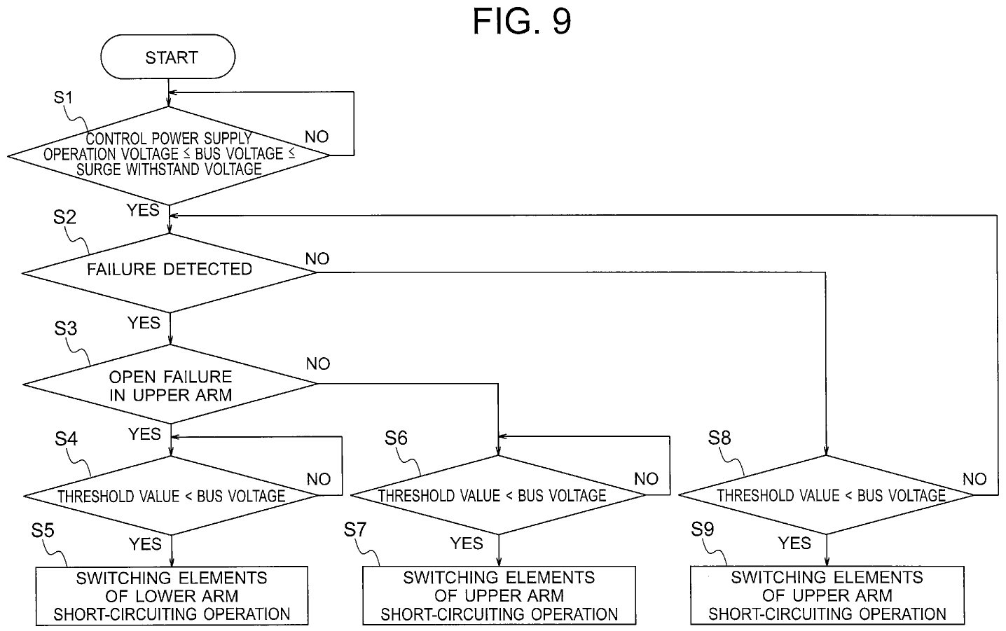

FIG. 9 is a flowchart showing the failure detection of the inverter 50 and the operation of the motor driving device 1. First, in step S1, the controller 70 operates in a condition that bus voltage detected by the DC voltage detector 40 is higher than or equal to a control power supply operation voltage enabling the operation of the controller 70 and less than or equal to a withstand voltage of the smoothing capacitor 21.

In the next step S2, the controller 70 detects the presence/absence of a failure in the switching elements 51 to 56 and the freewheeling diodes 51a to 56a constituting the inverter 50. When no failure is detected in the step S2 and the bus voltage is higher than a predetermined threshold value Vth (step S8), the switching elements 51, 52 and 53 of the upper arm 50a are short-circuited (set at ON) (step S9). In the case where there is no failure and the bus voltage is higher than the threshold value, it is permissible irrespective of which one of the upper arm and the lower arm is made to perform the short-circuiting (ON) operation.

When a failure in the switching elements 51 to 56 and the freewheeling diodes 51a to 56a constituting the inverter 50 is detected in the next step S2 whereas the open failure is not detected in the upper arm 50a (i.e., it is estimated that a failure exists in the lower arm 50b) in step S3 and the bus voltage is higher than the threshold value Vth (step S6), the controller 70 short-circuits (sets at ON) the switching elements 51, 52 and 53 of the upper arm 50a (step S7).

When the open failure is detected in the upper arm 50a in the next step S3 and the bus voltage is higher than the threshold value Vth (step S4), the controller 70 short-circuits (sets at ON) the switching elements 54, 55 and 56 of the lower arm 50b (step S5).

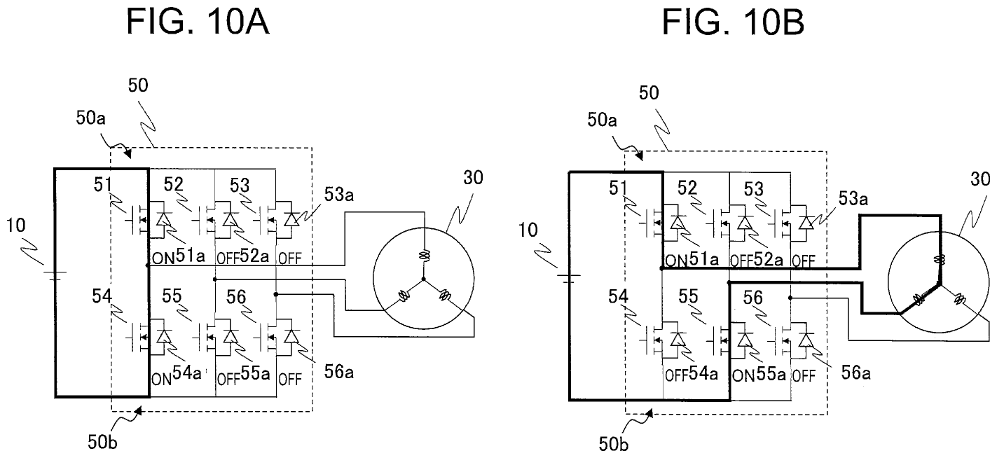

FIGS. 10A and 10B, FIGS. 11A and 11B, and FIGS. 12A and 12B are circuit diagrams showing paths of current when the failure detection is executed, by use of thick lines. First, as shown in FIG. 10A, the switching elements 51 and 54 are simultaneously set in the ON state and the other switching elements are set in the OFF state. When the switching elements 51 and 54 are normal, a short-circuiting current flows from the DC power supply 10 through the switching elements 51 and 54 as shown in FIG. 10A. However, when either one of the switching elements 51 and 54 is in the open failure, the short-circuiting current does not flow and thus it is found that either one of the switching elements 51 and 54 is in the open failure.

Subsequently, as shown in FIG. 10B, the switching elements 51 and 55 (or 56) are simultaneously set in the ON state and the other switching elements are set in the OFF state. A current due to the DC voltage flows via a winding in the motor 30 when the switching element 51 is normal, whereas the current does not flow when the switching element 51 is in the open failure.

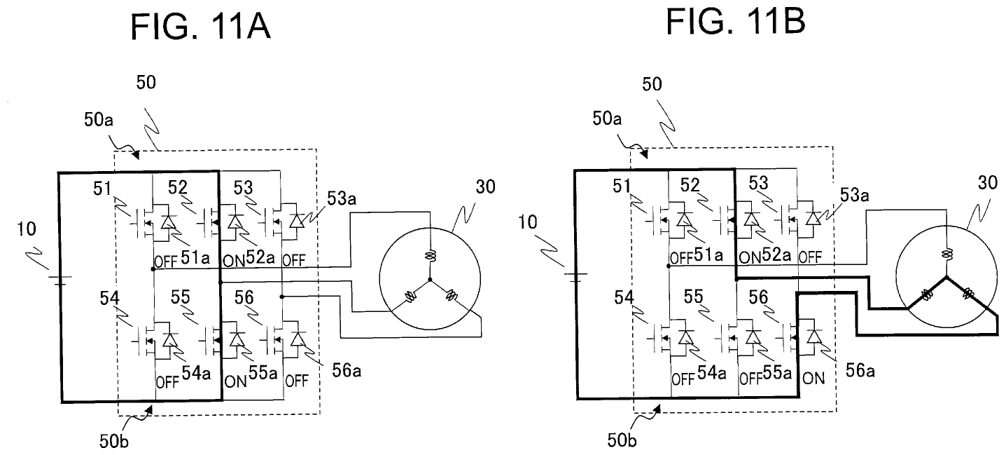

Subsequently, as shown in FIG. 11A, the switching elements 52 and 55 are simultaneously set in the ON state. When the switching elements 52 and 55 are normal, the switching elements 52 and 55 conduct current and the short-circuiting current flows from the DC power supply 10. However, when either one of the switching elements 52 and 55 is in the open failure, the short-circuiting current does not flow and thus it is found that either one of the switching elements 52 and 55 is in the open failure.

Subsequently, as shown in FIG. 11B, the switching elements 52 and 56 (or switching elements 52 and 54) are simultaneously set in the ON state. A current flows from the DC power supply 10 via a winding in the motor 30 when the switching element 52 is normal, whereas the current does not flow when the switching element 52 is in the open failure.

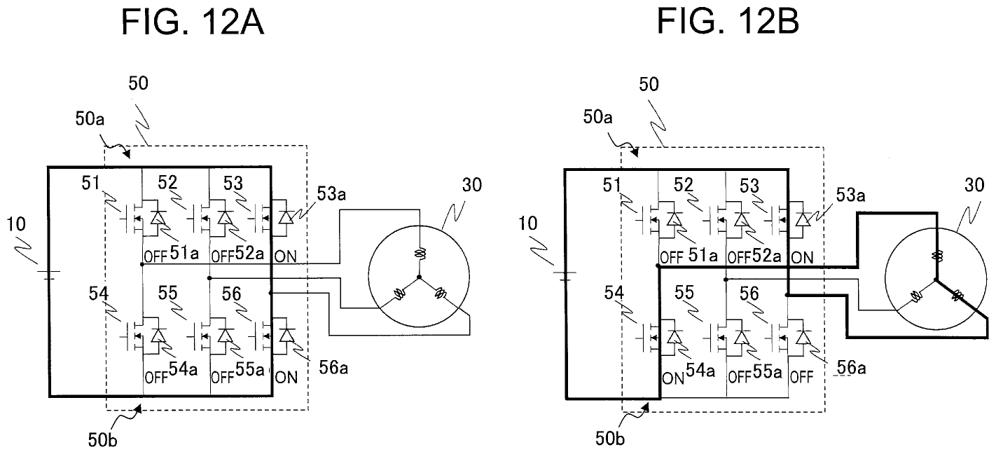

Subsequently, as shown in FIG. 12A, the switching elements 53 and 56 are simultaneously set in the ON state. When the switching elements 53 and 56 are normal, the switching elements 53 and 56 conduct current and the short-circuiting current flows from the DC power supply 10. However, when either one of the switching elements 53 and 56 is in the open failure, the short-circuiting current does not flow and thus it is found that either one of the switching elements is in the open failure.

Subsequently, as shown in FIG. 12B, the switching elements 53 and 54 (or 55) are simultaneously set in the ON state. A current flows from the DC power supply 10 via a winding in the motor 30 when the switching element 53 is normal, whereas the current does not flow when the switching element 53 is in the open failure.

As above, the position of a failed switching element (namely, failure position) can be identified by employing a configuration capable of controlling the operation of the switching elements 51 to 56 so as to identify the failure position and detecting the current flowing at that time.

As another method, there is a method that uses a charging current flowing from the motor 30 towards the DC power supply 10 when the regenerative voltage has occurred. For example, upon the occurrence of the regenerative voltage in the motor 30, a current flows in a path extending from the switching element 51 through the DC power supply and returning to the motor 30 through the switching element 55 or the switching element 56. However, if the switching element 51 is in the open failure, the current in this path does not flow. When a current does not flow as above at the time (timing) when a current should originally flow, it can be judged that the switching element 51, 52 or 53 of the inverter 50 is in failure.

Incidentally, this failure detection operation is desired to be executed in a state in which the regenerative voltage due to the motor 30 is low, that is, the number of revolutions (revolution speed) of the motor 30 is low. When the regenerative voltage due to the motor 30 is high and a switching element is in the open failure, excessive negative voltage occurs between switching elements in the open failure. For example, if there exists a peripheral circuit or the like for driving the switching elements, trouble can occur due to influence of the negative voltage. Therefore, the failure detection is desired to be executed in a state in which the negative voltage is low and the regenerative voltage is low. However, in the state in which the DC power from the DC power supply 10 is not supplied, the DC power is generated by the regenerative voltage of the motor 30. In order to put a failure detector in operation, a control power generated by the DC power supply 10 is necessary, and thus the supply of a certain amount of regenerative voltage is necessary. Thus, the DC power is generated by using the regenerative voltage within a range in which the negative voltage is permissible, and the failure detector is put in operation by using the control power obtained from the DC power supply 10. Thereafter, when the open failure of a switching element is detected, the failure due to the negative voltage can be prevented by setting the three-phase switching elements of the arm on the side with no failure in the ON state.

By this method, even when a switching element as a component of the inverter 50 is in the open failure, the effect of restraining the regenerative voltage can be expected. The above-described operation according to the flowchart is just an example; the operation is not limited to the above-described operation as long as the regenerative voltage is restrained by the controller 70 so as to prevent the short-circuiting operation of the arm on the side in failure.

As above, it becomes possible to restrain the regenerative voltage even when an element is in the open failure, and a motor driving device with high reliability, preventing the demagnetization of the motor 30 and the application of DC voltage higher than or equal to the withstand voltage, can be obtained.

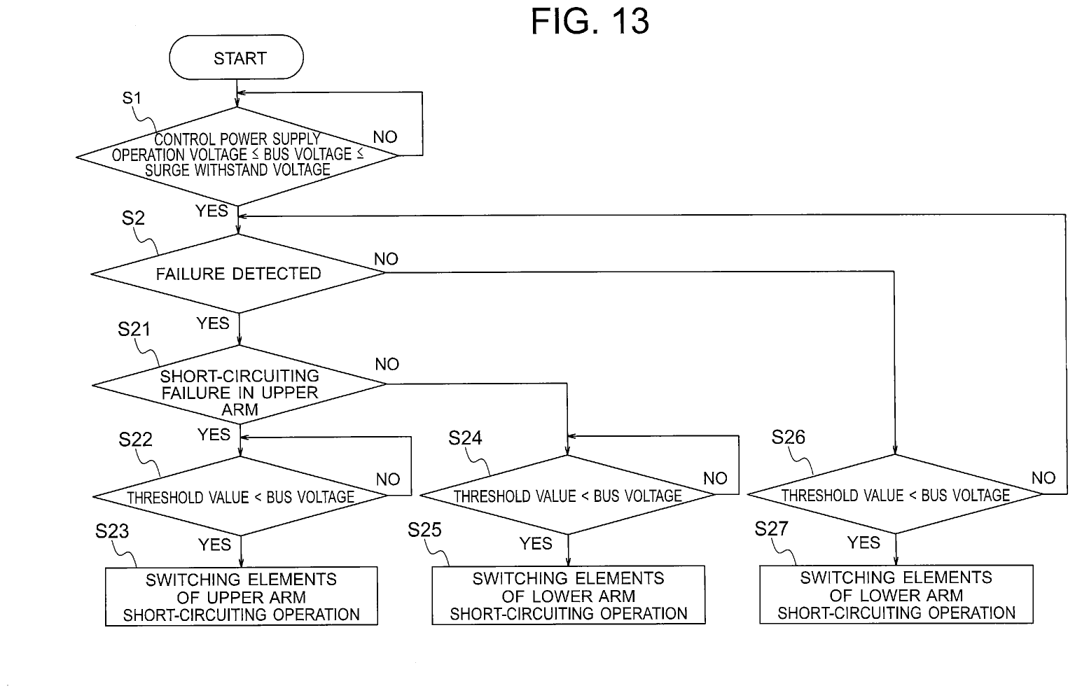

FIG. 13 is a flowchart showing the failure detection of the inverter 50 and the operation of the motor driving device 1. First, in the step S1, the controller 70 operates in the condition that the bus voltage detected by the DC voltage detector 40 is higher than or equal to the control power supply operation voltage enabling the operation of the controller 70 and less than or equal to the withstand voltage of the smoothing capacitor 21.

In the next step S2, the controller 70 detects the presence/absence of a failure in the switching elements 51 to 56 and the freewheeling diodes 51a to 56a constituting the inverter 50. When no failure is detected in the step S2 and the bus voltage is higher than a predetermined threshold value Vth (step S26), the switching elements 54, 55 and 56 of the lower arm 50b are short-circuited (set at ON) (step S27). In the case where there is no failure and the bus voltage is higher than the threshold value, it is permissible irrespective of which one of the upper arm and the lower arm is made to perform the short-circuiting (ON) operation.

When a failure in the switching elements 51 to 56 and the freewheeling diodes 51a to 56a constituting the inverter 50 is detected in the next step S2 and the short-circuiting failure is not detected in the upper arm 50a (i.e., it is estimated that a failure exists in the lower arm 50b) in step S21 and the bus voltage is higher than the threshold value Vth (step S24), the controller 70 short-circuits (sets at ON) the switching elements 54, 55 and 56 of the lower arm 50b (step S25).

When the short-circuiting failure is detected in the upper arm 50a in the next step S21 and the bus voltage is higher than the threshold value Vth (step S22), the controller 70 short-circuits (sets at ON) the switching elements 51, 52 and 53 of the upper arm 50a (step S23).

Incidentally, while the switching elements 51 to 56 of the inverter 50 are IGBTs as shown in FIG. 2, the switching elements 51 to 56 can be different switching elements such as MOSFETs (metal-oxide-semiconductor field-effect transistors).

Further, while the inverter 50 is configured as a three-phase bridge circuit as shown in FIG. 2, the same effect can be obtained also in cases where the inverter 50 is a two-phase circuit or formed with a plurality of bridge circuits if the controller 70 inputs the control signal to the inverter 50 so as to make the inverter 50 perform the short-circuiting operation and the opening operation.

Furthermore, there is a problem in that the controller 70 is incapable of operating when electric power is not supplied by the DC power supply 10. However, when the regenerative voltage occurring when the motor 30 is rotated forcibly becomes higher than or equal to a predetermined value, the same effect as the supply of the electric power by the DC power supply 10 is obtained and thus the controller 70 is enabled to operate.

### Effect of First Embodiment

In the motor driving device 1 according to the first embodiment, the malfunction of the circuit due to the occurrence of unexpected open state and short-circuiting path caused by an element failure can be prevented without the need of increasing the number of components and at a low cost. Accordingly, it becomes possible to use a permanent magnet synchronous motor having a large inductive voltage constant as the motor 30. Further, there is an advantage in that contributing also to energy saving is possible by reducing the loss occurring in the motor driving device 1 and mitigating the global warming is made possible.

### Second Embodiment

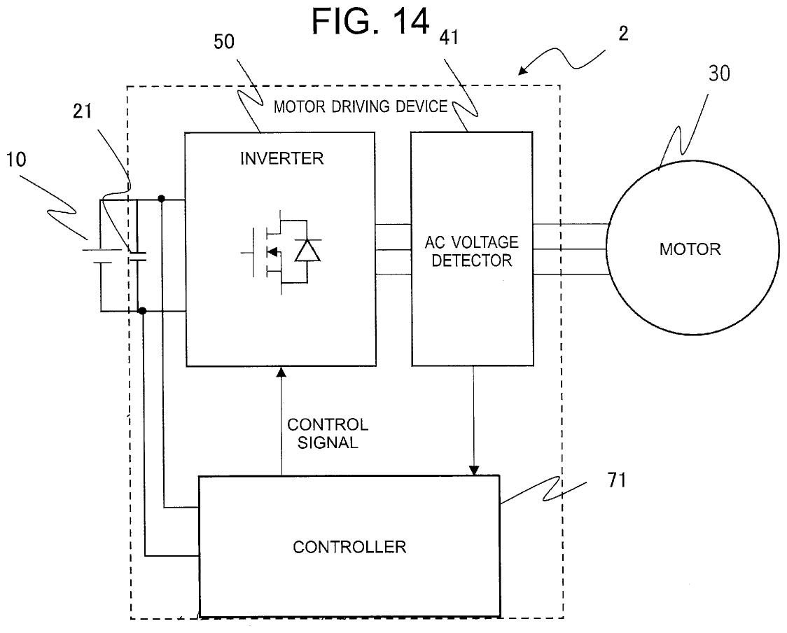

FIG. 14 is a diagram schematically showing the configuration of a motor driving device 2 according to a second embodiment. In FIG. 14, each component identical or corresponding to a component shown in FIG. 1 is assigned the same reference character as in FIG. 1. The motor driving device 2 according to the second embodiment differs from the motor driving device 1 according to the first embodiment in including an AC voltage detector 41 that detects AC voltage on the output side of the inverter 50 and in that a controller 71 controls the inverter 50 based on an AC voltage detection value detected by the AC voltage detector 41. In regard to the other components, the second embodiment is the same as the first embodiment.

In other words, the second embodiment differs from the first embodiment in that the physical quantity taken into the controller 71 changes from the DC voltage to the AC voltage and the predetermined threshold value changes to a threshold value regarding an AC voltage value. In the motor driving device 2 according to the second embodiment, the malfunction of the circuit due to the occurrence of unexpected open state and short-circuiting path caused by an element failure can be prevented without the need of increasing the number of components and at a low cost.

### Third Embodiment

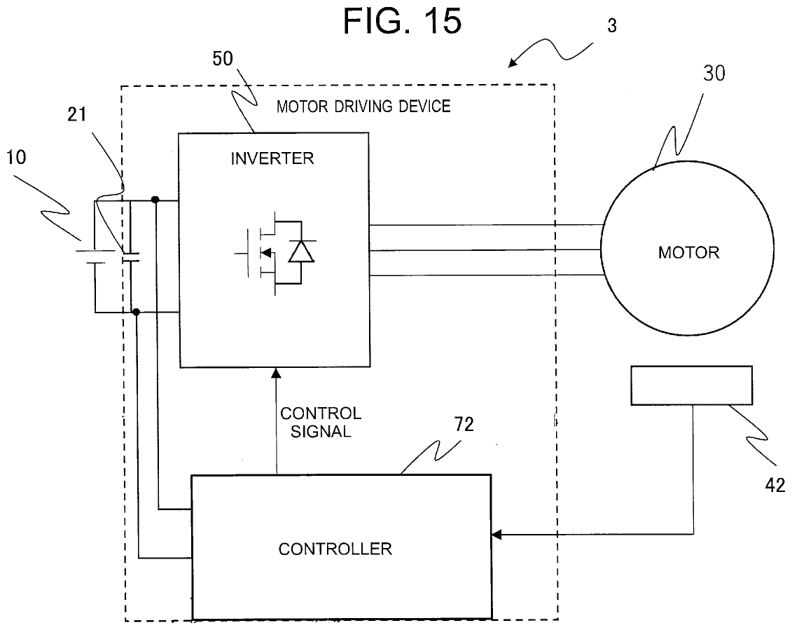

FIG. 15 is a diagram schematically showing the configuration of a motor driving device 3 according to a third embodiment. In FIG. 15, each component identical or corresponding to a component shown in FIG. 1 is assigned the same reference character as in FIG. 1. The motor driving device 3 according to the third embodiment differs from the motor driving device 1 according to the first embodiment in including a revolution speed detector 42 that detects the revolution speed of the motor 30 and in that a controller 72 controls the inverter 50 based on the revolution speed [rpm] detected by the revolution speed detector 42. In regard to the other components, the third embodiment is the same as the first embodiment.

In other words, the third embodiment differs from the first embodiment in that the physical quantity taken into the controller 72 changes from the DC voltage to the revolution speed and the predetermined threshold value changes to a threshold value regarding the revolution speed. In the motor driving device 3 according to the third embodiment, the malfunction of the circuit due to the occurrence of unexpected open state and short-circuiting path caused by an element failure can be prevented without the need of increasing the number of components and at a low cost.

### Fourth Embodiment

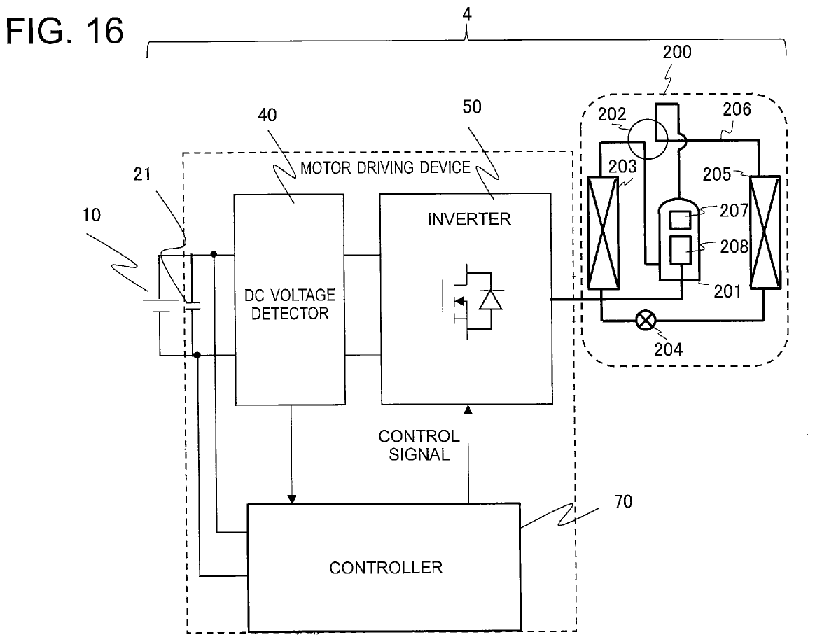

FIG. 16 is a diagram showing the configuration of an air conditioner 4 as a refrigeration cycle application apparatus according to a fourth embodiment. The air conditioner 4 includes the motor driving device 1 and a refrigeration cycle device 200. The air conditioner 4 is an air conditioner, a refrigerator, or the like, for example. The motor driving device 1 may be replaced with the motor driving device 2 or 3.

The refrigeration cycle device 200 includes a compressor 201, a four-way valve 202, an internal heat exchanger 203, an expansion mechanism 204, a heat exchanger 205, and refrigerant piping 206 successively connecting these components. Further, a compression mechanism 207 for compressing a refrigerant and a motor 208 (e.g., the motor 30 in the first to third embodiments) for driving the compression mechanism 207 are provided inside the compressor 201. Furthermore, the motor 208 is driven by the inverter 50 in any one of the motor driving devices 1 to 3.

In the air conditioner 4 according to the fourth embodiment, the malfunction of the circuit due to the occurrence of unexpected open state and short-circuiting path caused by an element failure can be prevented without the need of increasing the number of components and at a low cost. Accordingly, there is an advantage in that contributing also to energy saving is possible by reducing the loss occurring in the motor driving device 1 and mitigating the global warming is made possible.

### Modification

Each controller 70-72 in the above-described first to third embodiments can be formed with a CPU (Central Processing Unit), a DSP (Digital Signal Processor), a microcomputer (MCU), or the like, for example. For example, each controller 70, 71, 72 can be control circuitry formed with electric circuits or the like such as analog circuits or digital circuits.

The motor driving devices 1, 2 and 3 according to the above-described first, second and third embodiments are applicable to a ventilating fan, a washing machine, a vehicle such as an automobile, and so forth.

1. A motor driving device comprising:
an inverter to receive a DC voltage from a DC power supply and to output a voltage to a motor; and
control circuitry to detect a failure of the inverter and to control the inverter based on the detected failure,
wherein the inverter has
a plurality of first switching elements of an upper arm connected between a plus side of the DC power supply and the motor and a plurality of first freewheeling diodes respectively connected in parallel with the plurality of first switching elements, and
a plurality of second switching elements of a lower arm connected between a minus side of the DC power supply and the motor and a plurality of second freewheeling diodes respectively connected in parallel with the plurality of second switching elements, and
wherein while controlling all of the plurality of first switching elements and all of the plurality of the second switching elements to be in an OFF state in order to stop driving the motor, the control circuitry executes a control operation
of outputting a control signal for setting all of the plurality of second switching elements of the lower arm in an ON state when an open failure of any one of the first switching elements of the upper arm of the inverter is detected, and
of outputting a control signal for setting all of the plurality of first switching elements of the upper arm in the ON state when an open failure of any one of the second switching elements of the lower arm of the inverter is detected.

2. A motor driving device comprising:
an inverter to receive a DC voltage from a DC power supply and to generate a voltage to be inputted to a motor; and
control circuitry to detect a failure of the inverter and to control the inverter based on the detected failure,
wherein the inverter has
a plurality of first switching elements of an upper arm connected between a plus side of the DC power supply and the motor and a plurality of first freewheeling diodes respectively connected in parallel with the plurality of first switching elements, and
a plurality of second switching elements of a lower arm connected between a minus side of the DC power supply and the motor and a plurality of second freewheeling diodes respectively connected in parallel with the plurality of second switching elements, and
wherein while controlling all of the plurality of first switching elements and all of the plurality of the second switching elements to be in an OFF state in order to stop driving the motor, the control circuitry executes a control operation
of outputting a control signal for setting all of the plurality of first switching elements of the upper arm in an ON state when a short-circuiting failure of any one of the first switching elements of the upper arm of the inverter is detected, and
of outputting a control signal for setting all of the plurality of second switching elements of the lower arm in the ON state when a short-circuiting failure of any one of the second switching elements of the lower arm of the inverter is detected.

3. The motor driving device according to claim 1, wherein the control circuitry executes another control operation
of outputting a control signal for setting all of the plurality of first switching elements of the upper arm in the ON state when a short-circuiting failure of any one of the first switching elements of the upper arm of the inverter is detected, and
of outputting a control signal for setting all of the plurality of second switching elements of the lower arm in the ON state when a short-circuiting failure of any one of the second switching elements of the lower arm of the inverter is detected.

4. The motor driving device according to claim 1, further comprising a DC voltage detector to detect a voltage on an input side of the inverter, thereby outputting a voltage detection signal,
wherein the control circuitry controls the inverter based on the voltage detection signal.

5. The motor driving device according to claim 1, further comprising an AC voltage detector to detect a voltage on an output side of the inverter, thereby outputting a voltage detection signal,
wherein the control circuitry controls the inverter based on the voltage detection signal.

6. The motor driving device according to claim 1, further comprising a revolution speed detector to detect a revolution speed of the motor, thereby outputting a revolution speed signal,
wherein the control circuitry controls the inverter based on the revolution speed signal.

7. A refrigeration cycle application apparatus comprising:
the motor driving device according to claim 1; and
a refrigeration cycle device having a motor driven by the motor driving device.

8. The motor driving device according to claim 1, wherein the control circuitry receives a regenerative voltage generated by the motor, and executes the control operation by using the regenerative voltage.

9. The motor driving device according to claim 2, further comprising a DC voltage detector to detect a voltage on an input side of the inverter, thereby outputting a voltage detection signal,
wherein the control circuitry controls the inverter based on the voltage detection signal.

10. The motor driving device according to claim 2, further comprising an AC voltage detector to detect a voltage on an output side of the inverter, thereby outputting a voltage detection signal,
wherein the control circuitry controls the inverter based on the voltage detection signal.

11. The motor driving device according to claim 2 further comprising a revolution speed detector to detect a revolution speed of the motor, thereby outputting a revolution speed signal,
wherein the control circuitry controls the inverter based on the revolution speed signal.

12. A refrigeration cycle application apparatus comprising:
the motor driving device according to claim 2; and
a refrigeration cycle device having a motor driven by the motor driving device.

13. The motor driving device according to claim 2, wherein the control circuitry receives a regenerative voltage generated by the motor, and executes the control operation by using the regenerative voltage.
